(19) United States
(12) Patent Application Publication
(10) Pub. No.: US 2016/0225472 A1
(43) Pub. Date: Aug. 4, 2016

(54) POLYMERIC CHELATORS FOR METAL ION EXTRACTION AND SEPARATION

(71) Applicant: BOARD OF REGENTS, THE UNIVERSITY OF TEXAS SYSTEM, Austin, TX (US)

(72) Inventor: Bradley J. Holliday, Austin, TX (US)

(21) Appl. No.: 14/917,479

(22) PCT Filed: Sep. 9, 2014
(86) PCT No.: PCT/US2014/054822

§ 371 Date: Mar. 8, 2016

Related U.S. Application Data
(60) Provisional application No. 61/875,116, filed on Sep. 9, 2013.

(51) Int. Cl. G21C 19/46; C22B 3/24; C22B 60/02; G21F 9/06; G21F 9/12

(52) U.S. Cl. CPC G21C 19/46; G21F 9/06; G21F 9/12; C22B 60/0291; C22B 3/24; G21Y 2002/60; G21Y 2004/10

(57) ABSTRACT

The present invention provides a polymeric extractant with pendant chelator groups for selective sequestration of actinides and/or lanthanides comprising: a first block polymer comprising one or more CMPO monomers each having a first backbone bound to a pendant carbomylmethylphosphine oxide group; a second block polymer comprising one or more second monomers each having a second backbone bound to a second pendant group, wherein the first backbone is polymerized to the second backbone to form a polymer backbone with pendent blocks of the second pendant group and pendent blocks of pendent carbomylmethylphosphine oxide group that sequester the actinides and/or lanthanides; and optionally a third block polymer comprising one or more third monomers each having a third backbone bound to a third pendant group, wherein the one or more third monomers is polymerized to the first backbone and the second backbone.

### TECHNICAL FIELD OF THE INVENTION

The present invention relates in general to the field of processing and recycling irradiated nuclear fuels, and more particularly, to polymeric chelators for lanthanide/actinide extraction and separation.

### BACKGROUND OF THE INVENTION

Without limiting the scope of the invention, its background is described in connection with polymer chelators for lanthanide/actinide extraction and separation.

Nuclear waste reprocessing allows more energy to be produced from nuclear fuel and provides safer long term storage of the spent nuclear fuel. Nuclear fuel is made up primarily of uranium however trace impurities with extremely long half-lives that are created during power generation and result in a decrease in power generation efficiency and posing extreme engineering challenges to safely store.

The current process by which spent nuclear fuel rods are recycled involves dissolving the fuel in acidic aqueous media and then, through a series of liquid-liquid extractions, separating different elemental components of the mixture. The liquid-liquid extractions involve biphasic mixtures of organic solvents such as kerosene with the acidic aqueous fuel mixture. The process used to achieve the selective extraction and separation of the components of the mixture utilizes carefully designed chelator molecules that are dissolved in the organic solvent and selectively bind different ions in the fuel mixture.

Spent nuclear fuel contains many radioisotopes with half-lives on the order of 10³ years. This makes engineering an effective storage system to contain the material for the life of the radioactivity very difficult. With the advent of fast spectrum reactors many of these long lived products can be transmuted into shorter lived radioisotopes, creating more energy and less high level waste. This however, requires the separation of the various components in the fuel into separate waste streams. This is a difficult task, especially for obtaining selectivity between the lanthanides and actinides when considering the chemical similarities of these two classes of ions.

### SUMMARY OF THE INVENTION

One solution is a process termed partitioning and transmutation, whereby the various elements in the fuel are separated and then buried as less hazardous waste or transmuted into less harmful isotopes. Transmutation, however, requires that those elements with high neutron absorption cross sections first be removed. One of the most difficult processes of these separations involves the partitioning of actinides and lanthanides.

The present invention provides a polymeric extractant with pendant chelator groups covalently attached to the polymer backbone and selectively binds actinides over lanthanides, displays very high extraction efficiency, can achieve extractions in a single phase environment, has a modular design to easily incorporate new/different chelator groups or different monomer blocks with different properties for different applications or improved efficiency.

The present invention includes a polymeric material with pendant chelator functionalities that serve to efficiently and selectively bind ions in the aqueous media and transfer these ions to an organic solvent. Additionally, this polymeric material is synthesized upon a block copolymer backbone that allows other functional moieties to be incorporated either in separate blocks or randomly throughout the polymer backbone. The other functional groups can be used to impart important additional properties to the material. In one embodiment the polymeric chelator can be used in a single phase extraction procedure eliminating the need for the organic phase all together.

In its simplest form the present invention provides a polymeric material decorated with chelating groups which can selectively bind metal ions from an aqueous solution. Because this material is based on a block copolymer backbone, different groups can also be incorporated to change the efficiency, selectively, and mode of action of the chelating polymer. This material has a wide variety of uses including: chelation therapy, waste water remediation, water purification, and nuclear fuel reprocessing.

The present invention provides polymeric extractant materials with carbamoylmethylphosphine oxide (CMPO) pendent groups were prepared utilizing multiblock copolymers. The invention provides polymeric extractant materials with the addition of new polymeric blocks to influence additional functionalities of the polymeric extractant materials. The present invention provides the ability to selectively partition actinides utilizing both liquid-liquid and solid-liquid extractions. The extraction behaviour of the materials was significantly altered by the incorporation of new blocks. The incorporation of long glycol chains into the system caused an increase in the uptake of thorium(IV) over the CMPO homopolymers. The incorporation of blocks of long glycol chains and blocks of cross-linked hydroxcoumarian increased the selectivity significantly (Th (%)/Lanthanide (%) 2.3-4.5 times higher) over the homopolymer. Additional studies revealed very little decrease in performance in the presence of high nitric acid concentrations (e.g., 4 M) and varied material performance as a function of contact time in solid-liquid extraction conditions.

The present invention provides a new polymeric material with a polyoxanorbornene backbone and carbamoylmethylphosphine oxide, CMPO, ligand pendant groups with the ability to selectively partition actinides utilizing a biphasic extraction strategy. The polymeric materials had significantly higher (>5-25 times) ability to extract Th⁴⁺ than the monomeric system. The molecular weight of the material affected the extraction and separation abilities. The lower molecular weight material extracted more ions, but was less discriminate for thorium(IV) over cerium(III), lanthanum(III), and europium(III), than the higher molecular weight material. Structural modifications to this system were made by creating block copolymers. The influence of additional functionalities, created by the addition of new polymeric blocks, was investigated. The ability of the material to selectively partition actinides utilizing both solid-liquid and liquid-liquid extraction strategies was tested. Extraction efficiencies comparable to liquid-liquid extractions were achieved in the solid-liquid extractions. The extraction behavior of the materials was significantly altered by the incorporation of new blocks. The incorporation of glycol chains into the system caused an increase in the uptake of thorium(IV) over the homopolymers. The incorporation of blocks of glycol chains and blocks of cross-linked hydroxcoumarian increased the selectivity significantly (X_{Th/Eu} 2.3-4.5 times higher) over the homopolymer. These materials show tremendous promise as modular polymeric scaffolds.

The present invention provides a polymeric extractant with pendant chelator groups for selective sequestration of actinides and/or lanthanides comprising: a first block polymer comprising one or more CMPO monomers each having a first backbone bound to a pendant carbomylmethylphosphine oxide group; a second block polymer comprising one or more second monomers each having a second backbone bound to a second pendant group, wherein the first backbone is polymerized to the second backbone to form a polymer backbone with pendent blocks of the second pendant group and pendent blocks of pendent carbomylmethylphosphine oxide group that sequester the actinides and/or lanthanides; and optionally a third block polymer comprising one or more third monomers each having a third backbone bound to a third pendant group, wherein the one or more third monomers is polymerized to the first backbone and the second backbone.

The multi-block polymer composition may be disposed on a porous inert resin or silica support or used without a support for use in a solid-liquid extraction process or in solution for a liquid-liquid extraction process. The ratio of one or more CMPO monomers to one or more second monomers to one or more third monomers may be 2:1:0; 1:2:0; 2:1:1; or 2:4:1, and more specifically 2:1:0 with a Mw of about 1.36×10⁵; 1:2:0 with a Mw of about 1.32×10⁵; 2:1:1 with a Mw of about 6.28×10⁵; or 2:4:1 a Mw of about 6.28×10⁵. The pendent blocks of pendent carbomylmethylphosphine oxide group sequester actinides preferentially over lanthanides. The present invention may be used to isolate Th⁴⁺. The present invention may be used to isolate Th⁴⁺, La³⁺, Eu³⁺, and Ce³⁺. The one or more second monomers each comprise one or more glycol chains and the one or more third monomers each comprises a hydroxcoumarian group. In some embodiments the hydroxcoumarian groups are at least partially crosslinked.

The present invention provides a multi-block polymer composition for selective sequestration and separation of actinides and/or lanthanides comprising: a first block polymer comprising one or more CMPO monomers each having a first backbone bound to a pendant carbomylmethylphosphine oxide group; and a second block polymer comprising one or more second monomers each having a second backbone bound to a second pendant group, wherein the first backbone is polymerized to the second backbone to form a polymer backbone with pendent blocks of the second pendant group and pendent blocks of pendent carbomylmethylphosphine oxide group that sequester the multivalent ions.

The actinides and/or lanthanides may be selected from Th⁴⁺, La³⁺, Eu³⁺, and Ce³⁺ and more specifically Th⁴⁺. The multi-block polymer composition may be disposed on a porous inert resin or silica support or used without a support. The ratio of one or more CMPO monomers to one or more second monomers may be 2:1 or 1:2, e.g., 2:1 with a Mw of about 1.36×10⁵ or 1:2 with a Mw of about 1.32×10⁵. The second pendant group may be one or more long glycol chains and more specifically 2 polyethylene glycol groups.

The composition may further include a third block polymer comprising one or more third monomers each having a third backbone bound to a third pendant group, wherein the one or more third monomers is polymerized to the first backbone and the second backbone. The composition of claim 10, wherein the second pendant group may be 2 polyethylene glycol groups and the third pendant group may be a hydroxcoumarian group and the hydroxcoumarian group may or may not be at least partially crosslinked. The ratio of one or more CMPO monomers to one or more second monomers to one or more third monomers may be 2:1:1 with a Mw of about 6.28×10⁵ or 2:4:1 with a Mw of about 6.28×10⁵.

The present invention provides a process for separating actinides and/or lanthanides in the processing of a nuclear fuel comprising the steps of: providing a fluid mixture comprising fission products, lanthanides, actinides, nitric acid and water; providing a multi-block extractant polymer for selective sequestration and separation of separating actinides and/or lanthanides comprising a first block polymer comprising one or more CMPO monomers each having a first backbone bound to a pendant carbomylmethylphosphine oxide group; a second block polymer comprising one or more second monomers each having a second backbone bound to a second pendant group, wherein the first backbone is polymerized to the second backbone to form a polymer backbone with pendent blocks of the second pendant group and pendent blocks of pendent carbomylmethylphosphine oxide group that sequester the actinides and/or lanthanides; and optionally a third block polymer comprising one or more third monomers each having a third backbone bound to a third pendant group, wherein the one or more third monomers is polymerized to the first backbone and the second backbone; contacting the multi-block extractant polymer with the fluid mixture for the sequestration of the actinides and/or lanthanides by the pendant carbomylmethylphosphine oxide groups; and separating the multi-block extractant polymer from the fluid mixture to separate the actinides and/or lanthanides from the fluid mixture. The process may further comprising the step of disassociating the pendant carbomylmethylphosphine oxide group from the actinides and/or lanthanides and collecting the actinides and/or lanthanides.

The multi-block polymer composition may be disposed on a porous inert resin or silica support or used without a support for solid-liquid extractions or may be in the form of a liquid-liquid extraction process.

The ratio of one or more CMPO monomers to one or more second monomers to one or more third monomers may be 2:1:0 with a Mw of about 1.36×10⁵; 1:2:0 with a Mw of about 1.32×10⁵; 2:1:1 with a Mw of about 6.28×10⁵; or 2:4:1 a Mw of about 6.28×10⁵. The one or more second monomers may each comprise 2 polyethylene glycol groups. The one or more second monomers may each comprise one or more glycol chains and the one or more third monomers comprises a hydroxcoumarian group. The hydroxcoumarian groups may or may not be at least partially crosslinked. The actinides and/or lanthanides may be selected from Th⁴⁺, La³⁺, Eu³⁺, and Ce³⁺. The actinides and/or lanthanides may be Th⁴⁺.

A multi-block polymer composition for selective sequestration of ions having the structure:

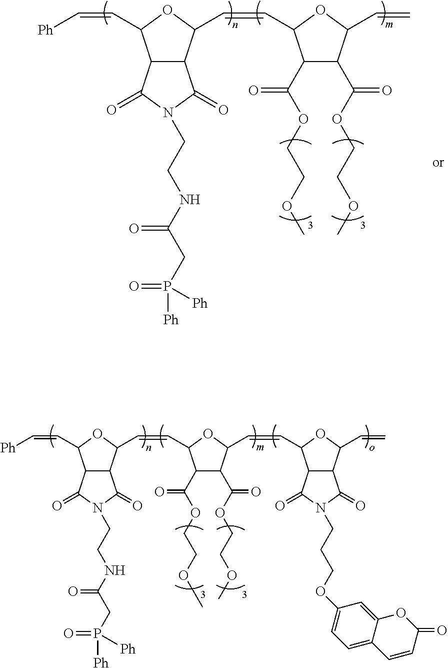

wherein the ratio of one or more CMPO monomers to one or more second monomers is 2:1 with a Mw of about 1.36×10⁵; the ratio of one or more CMPO monomers to one or more second monomers is 1:2 with a Mw of about 1.32×10⁵; the ratio of one or more CMPO monomers to one or more second monomers to one or more third monomers is 2:1:1 with a Mw of about 6.28×10⁵; or the ratio of one or more CMPO monomers to one or more second monomers to one or more third monomers is 2:4:1 with a Mw of about 6.28×10⁵. The hydroxcoumarian groups may or may not be at least partially crosslinked.

The present invention provides a multi-block polymer composition for selective sequestration actinides and/or lanthanides comprising: 2 or more blocks of monomers polymerized to form a multiblock polymer, wherein the 2 or more blocks of monomers are selected from

one or more CMPO monomers having the structure,

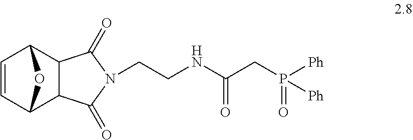 [SMILES: O=C(CP(=O)(c1ccccc1)c1ccccc1)NCCN1C(=O)C2C(C1=O)[C@H]1C=C[C@@H]2O1]

one or more second monomers having the structure,

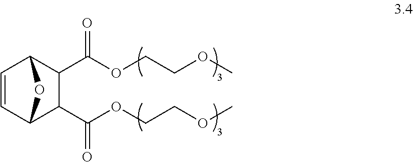

one or more third monomers having the structure

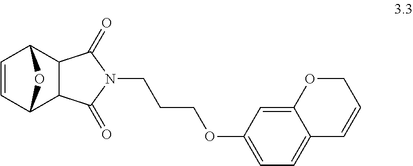 [SMILES: O=C1C2C(C(=O)N1CCCOc1ccc3c(c1)OCC=C3)[C@H]1C=C[C@@H]2O1]

and
one or more forth monomers having the structure

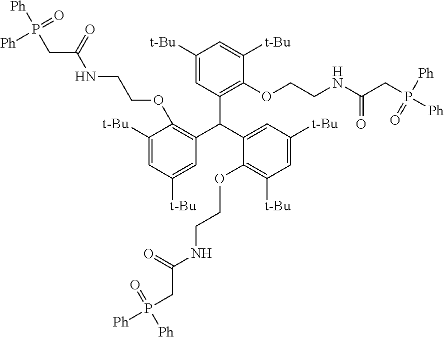 [SMILES: CC(C)(C)c1cc(C(c2cc(C(C)(C)C)cc(C(C)(C)C)c2OCCNC(=O)CP(=O)(c2ccccc2)c2ccccc2)c2cc(C(C)(C)C)cc(C(C)(C)C)c2OCCNC(=O)CP(=O)(c2ccccc2)c2ccccc2)c(OCCNC(=O)CP(=O)(c2ccccc2)c2ccccc2)c(C(C)(C)C)c1]

The present invention provides a multi-block polymer composition for selective sequestration actinides and/or lanthanides comprising: 1, 2, 3, 4 or more monomers polymerized to form a homoblock or multiblock polymer, wherein the 1, 2, 3, 4 or more blocks of monomers are selected from

one or more CMPO monomers having the structure

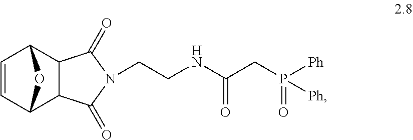 [SMILES: O=C(CP(=O)(c1ccccc1)c1ccccc1)NCCN1C(=O)C2C(C1=O)[C@H]1C=C[C@@H]2O1]

one or more second monomers having the structure

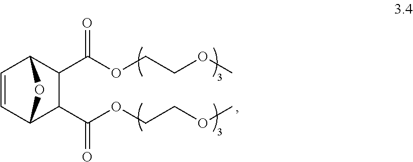

and

one or more third monomers having the structure

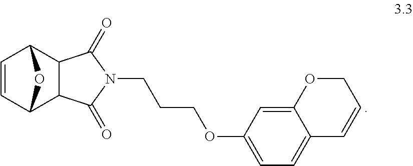 [SMILES: O=C1C2C(C(=O)N1CCCOc1ccc3c(c1)OCC=C3)[C@H]1C=C[C@@H]2O1]

### BRIEF DESCRIPTION OF THE DRAWINGS

For a more complete understanding of the features and advantages of the present invention, reference is now made to the detailed description of the invention along with the accompanying figures and in which:

FIG. 1 shows CMPO-derivatized linear compounds.

FIG. 2 is a schematic showing actinides selectively sequestered from an aqueous phase into an organic phase by a CMPO containing material.

FIG. 3 is a scheme of the synthesis of ROMP active amines.

FIG. 4 is a scheme of the synthesis of CMPO starting materials.

FIG. 5 is a scheme of the synthesis of monomer and polymer CMPO chelators.

FIG. 6 is a plot of observed molecular weight versus monomer/catalyst ratio for polymers.

FIG. 7 shows a thermogravametric analysis of one embodiment, mass percent versus temperature.

FIG. 8 is a schematic showing actinides selectively sequestered from an aqueous phase into a solid phase by a CMPO containing material.

FIG. 9 is a scheme of the synthesis of homopolymers and homopolymer precursors.

FIG. 10 shows a plot of the observed molecular weight versus monomer/catalyst ratio for polymers.

FIG. 11 is a scheme of the synthesis of homo and block copolymers.

FIG. 12A is a schematic showing the crosslinking of triblock terpolymers.

FIG. 12B is a plot showing UV-Vis spectra of composition 3.8b in CH₂Cl₂ against irradiation time with a UV lamp.

FIG. 13 is a schematic showing the polymers interacting with thorium.

FIGS. 14A-14C are schematics of variations of polymers of the present invention which include homopolymers (FIG. 14A), diblock copolymers (FIG. 14B) and triblock terpolymers (FIG. 14C) of different molecular weights.

FIG. 14D is a plot of the percent extraction of Th⁴⁺ in a liquid-liquid extraction as a function of Molarity of CMPO.

FIG. 14E is a plot of the percent extraction of Th, Eu, La, and Ce (from left to right) in a liquid-liquid extraction with 0.01 M CMPO homopolymers.

FIG. 14F is a plot of the percent extraction of Th⁴⁺ in a solid-liquid extraction as a function of molarity of CMPO.

FIG. 14G is a plot of the percent extraction of Th⁴⁺ in a solid-liquid extraction for 0.005M CMPO as a function of Molarity of acid.

FIG. 14H is a plot of the percent extraction of Th, Eu, La, and Ce (from left to right) in a solid-liquid extraction with 0.005 M CMPO polymers.

FIG. 15 is an image of some of the monomers of the present invention.

FIG. 16 is an image of some of the monomers polymerized into a block polymer.

FIGS. 17a and 17b are images of some of the ligands of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides a polymeric material with a polyoxanorbornene backbone and carbamoylmethylphosphine oxide, CMPO, ligand pendant groups. The material of the present invention allows the selective partition of actinides utilizing a biphasic extraction strategy has been tested. The polymeric materials had significantly higher (>5-25 times) ability to extract Th⁴⁺ than the monomeric system. The CMPO-based scheme provides a modular approach that is beneficial for practical implementation allowing easy manipulation of the molecular weight of the polymers and in turn the extraction and separation abilities. The lower molecular weight material extracted more ions, but was less discriminate for thorium over cerium, lanthanum, and europium, than the higher molecular weight material. These materials may be formed into as modular polymeric scaffolds for the selective extraction of metal ions from aqueous media.

The present invention includes a polymeric material with pendant chelator groups covalently attached to the polymer backbone and that it can be incorporated into a block copolymer to modify the chelating properties. The polymers of the present invention may be impregnated into polymer or bead materials which does not show high selectivity and can suffer from leaching of the chelators. The present invention provides a simple, modular, and highly stable polymeric chelator that shows good performance and can be easily varied to optimize the properties. Additionally, the polymeric system has the advantage of easy separation from the aqueous medium and, in the case of nuclear fuel reprocessing, the ability to be used in a single phase extraction scheme.

Demonstrated in the transuranic extraction (TRUEX) process was the ability of the carbomylmethylphosphine oxide (CMPO) ligand to selectively bind to actinides over lanthanides. Reprocessing spent fuel begins with the dissolution of the fuel rods in nitric acid. In the TRUEX process actinides are sequestered from the aqueous acidic media into an organic medium by chelation through the carbonyl and phosphoryl oxygens of three CMPO ligands. Efforts to improve separation factors have currently focused on preorganizing several CMPO moieties onto a small molecule substrate. In this effort a variety of different small molecule platforms have been developed.

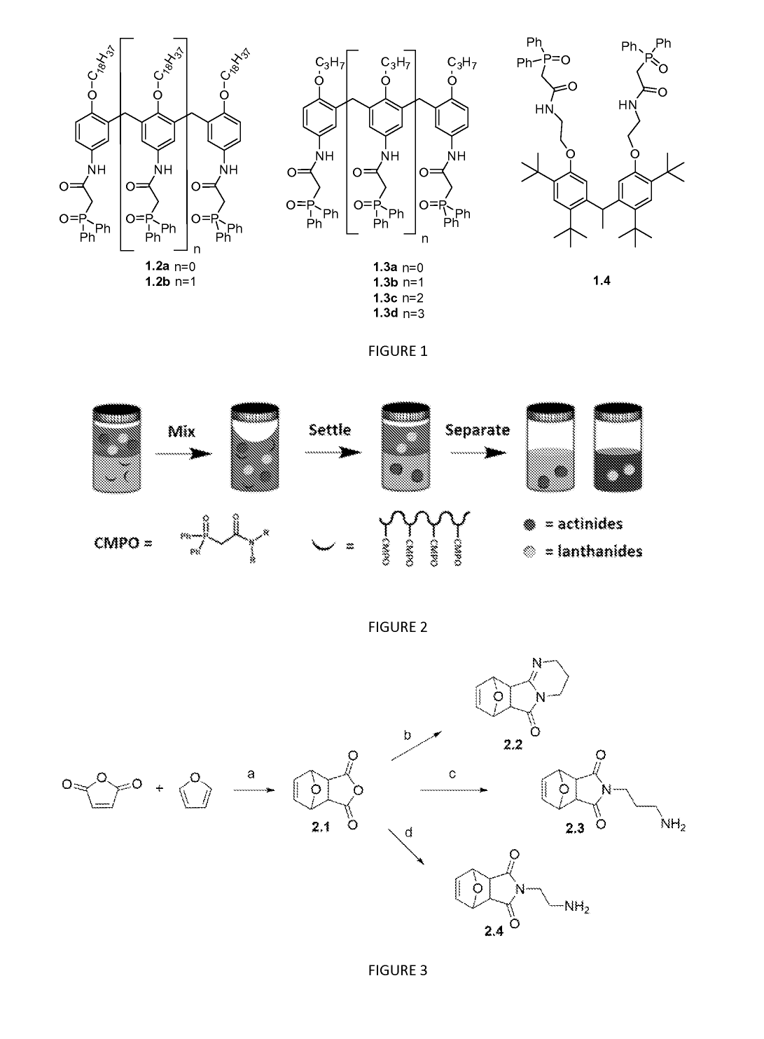

FIG. 1 shows CMPO-derivatized linear compounds. The simplest system which covalently binds two or more CMPO units together is the linear oligomer system. Unlike the other systems which typically have 3-4 CMPO units, the linear systems vary more widely with 2-5 CMPO units. Many of these systems are structurally very similar to calixarenes, with methyl linked phenols. The linear oligomer systems have been studied for their ability to extract thorium(IV) and europium(III), the results are summarized in Table 1.1 below showing extraction (% E) of thorium(IV) and europium(III) by linear oligomer compounds.

| | | Equiv of ligand in | | |
|---|---|---|---|---|
| # CMPOs | Ligand | Organic phase | % Th | % Eu |
| 2 | 1.2a⁸ | 1 | 17 | |
| | | 10 | | <3 |
| 3 | 1.2b⁸ | 1 | 78 | |
| | | 10 | | <3 |
| 2 | 1.3a¹⁰ | 10 | 6 | |
| | | 100 | | 4 |
| 3 | 1.3b¹⁰ | 10 | 18 | |
| | | 100 | | 24 |
| 4 | 1.3c¹⁰ | 1 | 35 | |
| | | 10 | | 56.5 |
| 5 | 1.3d¹⁰ | 1 | 31 | |
| | | 10 | | 38.1 |
| 2 | 1.4⁹ | 10 | 4 | 6 |

Equal volumes organic/aqueous phases, organic phase: CH₂Cl₂, aqueous phase: 1 M HNO₃, CM=10⁻⁴ M.

Compounds 1.2a and 1.2b both show discrimination for thorium(IV) over europium(III). The importance of the chelate effect is observed in the comparison of the performance of these two materials. Compound 1.2b, which has three CMPO arms binds to significantly more thorium(IV) than compound 1.2a, which has only two CMPO arms. Unlike many other materials, the increased uptake of throium(IV) is not accompanied by an increase in the uptake of the lanthanide europium(III). This results in an increase in extraction as well as separation efficiency by the addition of a third CMPO unit. Compounds 1.3a 1.3d vary only in the length of the alkyl chain on the phenol from compounds 1.2a-1.2b. This difference has resulted in drastically different chelation properties. While compound 1.2a was able to extract 17% of the present thorium(IV) at 1:1 (ligand:Th⁴⁺), the shortening of the alkyl chain resulted in a decrease to 6% for compound 1.3b at 10:1 (ligand:Th⁴⁺). A similar trend was observed for compounds 1.2b and 1.3b, where compound 1.2b extracted 78% of the thorium at 1:1 (ligand:Th⁴⁺), and compound 1.3b extracted only 18% with a higher concentration of ligand (10:1, ligand:Th⁴⁺). Additionally compounds 1.3a and 1.3b extracted increased amounts of europium(III) than their counterparts with shorter alkyl chains, compounds 1.2a and 1.2b. Decreasing the length of the alkyl chain resulted overall in a decrease in both the extraction and separation efficiencies. When the number of repeat units is increased in system 1.3, an increase is observed in the extraction of both thorium(IV) and europium(III). This increase continues from dimer to tetramer, but decreases again for the pentamer. The separation efficiency decreases from dimer to tetramer, and then increases again for the pentamer. The switch to a different linear oligomer platform, 1.4, gave vastly different extraction values than the dimers 1.2a and 1.3a. Compound 1.4 extracted small quantities of europium(III), yet it is not discriminate; at equal ligand concentrations, complex 1.4 actually showed an increased selectivity for europium(III). Compounds 1.2a and 1.2b were also tested for their ability to selectively chelate americium(III). These systems were found to be selective for americium(III) over europium(III). The increase from 2 to 3 CMPOs resulted in a slight decrease for the selectivity, but resulted in a large increase in the affinity for americium(III). Generally the linear systems displayed increased extraction efficiencies with additional CMPO moieties which may be due to an increased chelate effect. Also the linear systems displayed increased extraction and separation efficiencies with longer alkyl chains on the platform, possibly due to an increase in solubility.

FIG. 2 is a schematic showing actinides selectively sequestered from an aqueous phase into an organic phase by a CMPO containing material. A series of CMPO tethered polymers were synthesized largely through modified literature procedures. Compound 2.4 was prepared through a condensation between the Diels-Alder product 2.1 and ethylenediamine. First attempts at this reaction were performed with 1,3-diaminopropane and resulted in the formation of compound 2.2. It was found later that by lowering the reaction temperature, compound 2.3 could be synthesized through the aminolysis of p-nitrophenyl (diphenylphosphoryl) acetate.

FIG. 3 is a scheme of the synthesis of ROMP active amines, compounds 2.1-2.4, where (a) is benzene, RT, 18 h, 81.5% (b) 1,3-diaminopropane, 70° C., 2 h, 23.5% (c) 1,3-diaminopropane, RT, 2 h, 12.1% (d) 1,2-diaminoethane, 70° C., 2 h, 9.9%.

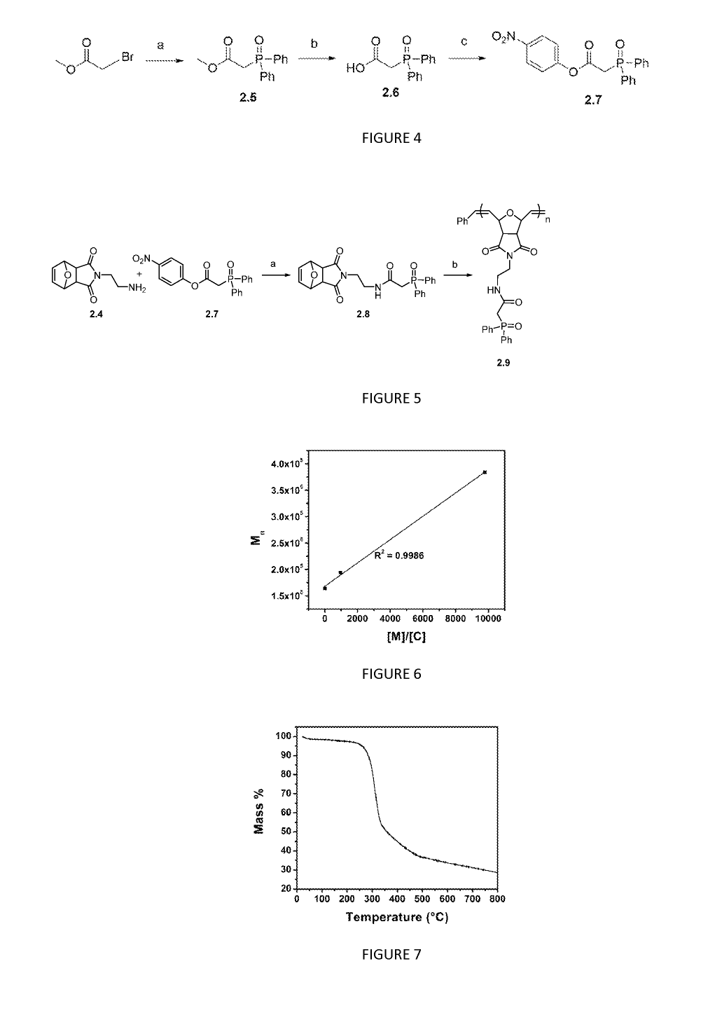

FIG. 4 is a scheme of the synthesis of CMPO starting materials, compounds 2.5-2.7. (a) [1] chlorodiphenylphosphine, Zn, I₂, benzene, 70° C., 18 h [2] HOOH, ethanol, RT, 1 hr., 74.8% (b) NaOH, methanol/H₂O, 70° C., 18 hrs., 84.4% (c) 4-nitrophenol, CHCl₃, 45° C., 5 hrs., 77.7%. Compound 2.5 was synthesized in a Reformatsky-type reaction between chlorodiphenylphosphine and methylbromoacetate, followed by oxidation with hydrogen peroxide, adapted from Kie [symbol] basiński and Miko [symbol] ajczyk. The carboxylic acid, compound 2.6, was synthesized by hydrolysis of compound 2.5. Attempts to directly synthesize compound 2.6 with bromoacetic acid in place of methylbromoacetate were unsuccessful. Various unsuccessful attempts were made to couple compound 2.6 with compound 2.4. Eventually compound 2.6 was functionalized with a p-nitrophenol leaving group to create compound 2.7.

FIG. 5 is a scheme of the synthesis of monomer and polymer CMPO chelators, compounds 2.8-2.9. (a) CHCl₃, 45° C., 18 h, 67.1% (b) 2^{nd} generation Grubbs' catalyst, CHCl₃, RT, 18 h, 55.7%. The monomer, 2.8, was then prepared in good yields through the aminolysis of compound 2.7 by compound 2.4. The X-ray crystal structures of compounds 2.4 and 2.8 reveal that the exo isomer of the bridged bicyclic ring system is exclusively formed, yielding the monomer more active towards polymerization. Three polymers of varying molecular weights were synthesized (compounds 2.9a-c). The relationship between the observed molecular weight and the molar ratio of catalyst to monomer was found to be linear indicating a controlled living polymerization. The decomposition temperature of compound 2.9c was investigated by thermogravimetric analysis and found to be 250° C.

FIG. 6 is a plot of observed molecular weight (Mn) versus monomer/catalyst ratio ([M]/[C]) for polymers 2.9a-c.

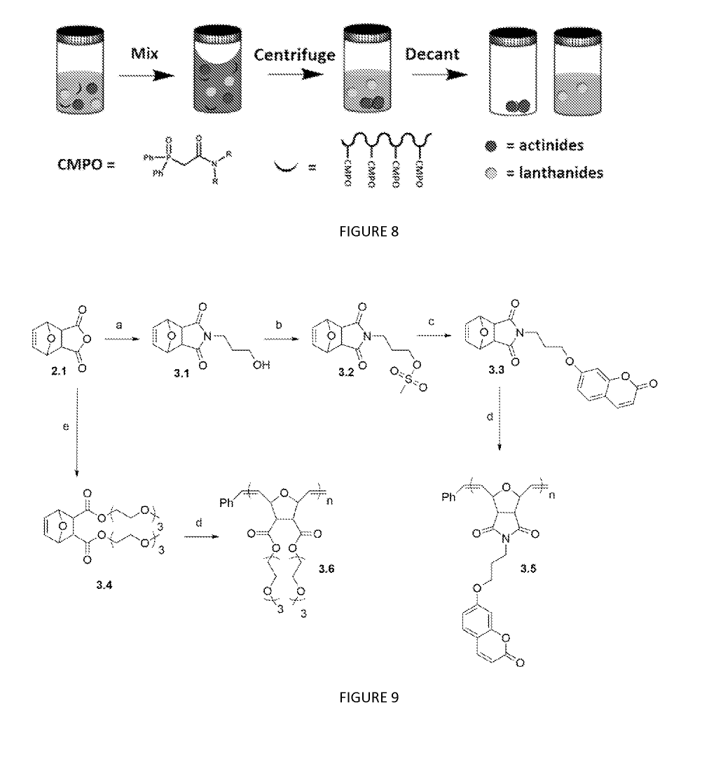

FIG. 7 shows a thermogravametric analysis of compound 2.9c, mass percent versus temperature (° C.). The extraction efficiencies of the monomer, 2.8, and polymers 2.9a-c were investigated. The efficiencies were tested by performing a liquid-liquid extraction with metal nitrates in aqueous acidic media, which were extracted into organic media by ligands in the organic phase. For initial testing, the aqueous phase used was 10⁻⁴ M Th⁴⁺ in 1 M HNO₃ to replicate the conditions used in the literature, to allow for simple comparison between the different materials. Choices for the organic phase were limited due to the solubility of the materials. Ultimately CH₂Cl₂ was chosen due to its popularity in CMPO extractions. As a control, the first extraction was performed with pure CH₂Cl₂, containing no CMPO material, to ensure that the extraction ability of the system is due entirely to the CMPO materials and not due to the solubility of the metal nitrates in CH₂Cl₂. The extraction ability of CH₂Cl₂ was found to be <1±3%.

The extraction of thorium(IV) was performed with varying concentrations of extracting material, 0.05 M-0.001 M. The concentration of the polymeric materials was determined by using by using the same gram quantity as the monomer at each concentration, giving one mole of repeat unit per liter. The results of these tests are summarized in the table of Extraction efficiencies for selected materials below:

| [CMPO] | 2.8 | 2.9a | 2.9b | 2.9c |
|---|---|---|---|---|
| 0.05M | 82 | 65 | >99 | >99 |
| 0.01M | 7 | 34 | >99 | >99 |
| 0.005M | 4 | 21 | >99 | >99 |
| 0.001M | <1 | 16 | 40 | 93 |

Percent of Th⁴⁺ extracted from 1M HNO₃ solutions by ligands. Aqueous phase: 10⁻⁴ M Th(NO₃)₄.H₂O, Organic phase: extracting materials in CH₂Cl₂. For the monomer 2.8, high extraction values could be obtained with 1000 times greater CMPO to metal concentration, but sharply declined to 7% at 100 times greater concentration. All the polymeric materials outperformed the monomer, 2.8. Polymers 2.9b and 2.9c were able to achieve quantitative extractions at only 50 times greater CMPO to metal concentration. Though the performance of 2.9b sharply declines at 10 times CMPO to metal concentration, compound 2.9c still extracts over 90% of the metal ions. Quantitative extraction was not achieved with compound 2.9a and at very high ligand concentrations the monomer does outperform compound 2.9a, but as the concentration of the materials is decreased the polymer significantly outperforms the monomer.

At 0.01 M, for example, the polymer binds to 5 times more Th⁴⁺ than the monomer. It is believed that as the concentration of monomer is decreased it becomes more and more difficult for three CMPO groups to find a metal ion and complete extraction. As the concentration of the polymer is decreased the “localized concentration” remains the same. Because many CMPO groups are linked together despite the solution being somewhat dilute. As a result, the CMPO ligands can take place in cooperative binding in the case of the polymers, but not in the case of the monomers. Looking at the differences between the three polymers, it is clear that molecular weight does play a role in the extraction efficiency of the materials. These differences can be attributed to the differing solubilities of the three materials. It is unclear if binding is occurring between three adjacent CMPO units or by CMPO units on adjacent chains. But it is believed that three adjacent CMPO moieties are binding because at low concentrations, where the likely hood of multiple chains coming in contact is small, high extraction efficiencies are achieved. Quantitative extractions were achieved with 0.005 M or 0.0017 M, when decreasing by three, with 2.9b and 2.9c. This is quite comparable to the other platform systems in which most achieve quantitative extraction with Th⁴⁺ at 0.001 M.

To determine the separation efficiency of the materials, lanthanides were added to the extractions. Three lanthanides were chosen: lanthanum(III), europium(III), and cerium(III). To keep the same overall metal concentration of 10⁻⁴ M, the concentration of each individual metal was set at 2.5×10⁻⁵ M, so the final solution contained 2.5×10⁻⁵M Th⁴⁺, La³⁺, Eu³⁺, and Ce³⁺. The separation values were determined by dividing the distribution of thorium(IV) by the distribution of a given ion. A larger value indicates a higher preference to extract thorium(IV) over a given ion. Table of separation efficiencies for polymeric materials.

| | 2.9a | 2.9b | 2.9c |
|---|---|---|---|
| S_{Th/Eu} | 327.7 | 16.7 | 15.6 |
| S_{Th/La} | 175.6 | 18.7 | 5.7 |
| S_{Th/Ce} | 123.8 | 13.0 | 5.7 |

S_{Th/M} values for extraction of Th⁴⁺, Ce³⁺, La³⁺, and Eu³⁺ (C_{M}=2.5×10⁻⁵ M) from an aqueous solution of 1 M HNO₃ into a CH₂Cl₂ solution of polymers (C_{CMPO}=0.01 M) at 25° C. It is clear that all the materials have a preference for thorium(IV) over the lanthanides. The highest molecular weight polymer 2.9a, is the most discriminate towards thorium(IV), with much higher separation values than the other materials. The smallest molecular weight polymer has the lowest separation values for all of the ions tested, revealing a trend of better separations with higher molecular weight materials. The trend of increasing separation efficiency with increasing size has also been shown between single CMPO systems and platform CMPO systems, where multiple CMPO containing systems have shown a higher preference for actinides than homologous single CMPO containing systems. The high extraction efficiencies with the smaller polymer and the high separation efficiencies with the higher molecular weight polymer lead us to believe that there is a so called “sweet-spot” for idealized molecular weight, where both extraction and separation efficiencies can be maximized.

The present invention provides an improvement in CMPO chelation by tethering the ligand to a polymeric backbone. All three polymers are better extractants than the monomer and the polymer performance can be a function of molecular weight. While the higher molecular weight polymer, 2.9a, has an increased separation efficiency as compared to the lower molecular weight polymers, the lowest molecular weight polymer, 2.9c, has the highest extraction efficiency. The extraction efficiencies demonstrated by 2.9b and 2.9c are comparable to the performance other CMPO platform systems.

FIG. 8 is a schematic showing actinides selectively sequestered from an aqueous phase into a solid phase by a CMPO containing material.

FIG. 9 is a scheme of the synthesis of homopolymers and homopolymer precursors 3.1-3.6, condition “a” is 3-amino-1-propanol, MeOH, 66° C., 18 hrs., 48.3%, condition “b” methanesulfonyl chloride, Et₃N, CH₂Cl₂, 0° C., 4 h, 83.7%, condition “c” 7-hydroxycoumarin, K₂CO₃, CH₃CN, 82° C., 18 hrs., 30.8%, condition “d” Grubb's second generation catalyst, CHCl₃, 25° C., condition “e” triethylene glycol monomethyl ether, 2-chloro-1-methylpyridinium iodide, Et₃N, DMAP, CH₂Cl₂, 40° C., 40 hrs., 75.85%. The monomers 3.3 and 3.4 were synthesized as shown in FIG. 9. Compound 3.1 was converted into the mesylate 3.2 with triethylamine and methanesulfonyl chloride. 7-hydroxycoumarin was deprotonated with potassium carbonate and reacted with compound 3.2 to form the monomer 3.3. Monomer 3.4 was prepared according to a procedure by Sleiman and coworkers. The polymerizations were carried out using Grubbs' second generation catalyst in CHCl₃ for all of the polymers. To investigate the living nature of the materials, three homopolymers of compound 3.3 were first synthesized. The polymers were found to have a linear relationship between observed molecular weight and the ratio of monomer to catalyst used. A homopolymer of 3.4 was synthesized to study the materials chelating properties.

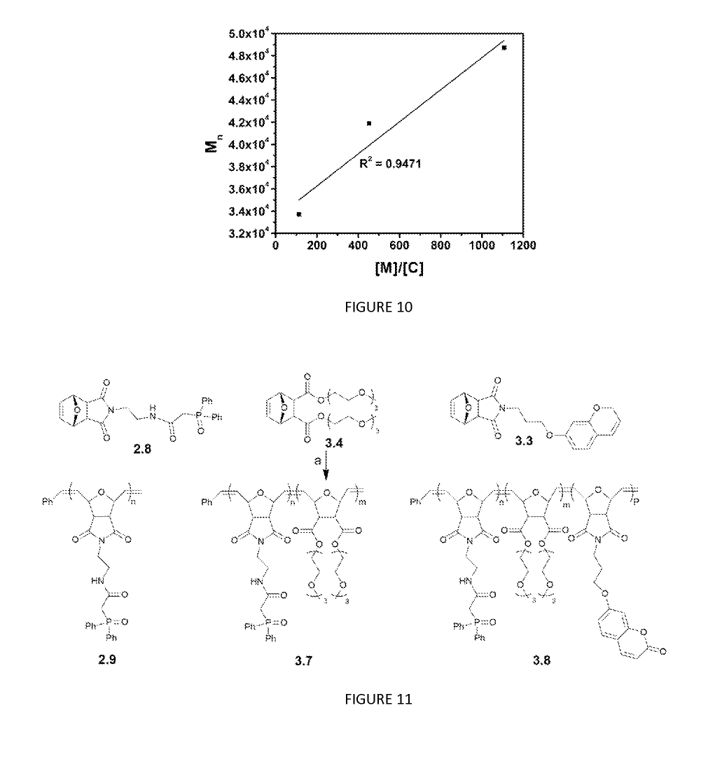

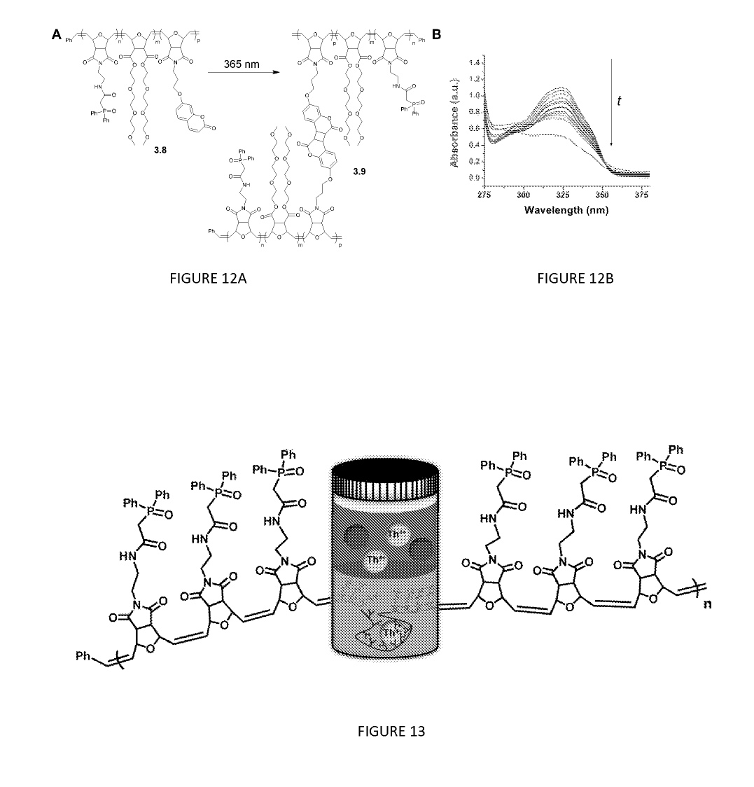

FIG. 10 shows a plot of the observed molecular weight (Mn) versus monomer/catalyst ratio ([M]/[C]) for polymers 3.6a-c. Two diblock copolymers containing both compositions 2.8 and 3.4 were synthesized. The molar ratio of composition 2.8 to the catalyst was kept the same in both polymerizations, but the amount of composition 3.4 was varied, with polymer 3.7a having a ratio of 2:1 for 2.8:3.4 and polymer 3.7b having a ratio of 2:4 for 2.8:3.3. Two triblock polymers were synthesized containing 2.8, 3.3, and 3.4. In these polymers the ratio of 2.8 to the catalyst and the ratio of 3.3 to the catalyst were kept constant. Polymer 3.8a contains the blocks in the ratio 2:1:1 (2.8:3.4:3.3) and polymer 3.8b has a ratio of 2:4:1 (2.8:3.4:3.3). All of the block copolymers were found to have high molecular weights.

FIG. 11 is a scheme of the synthesis of homo and block polymers 2.9, 3.7-3.8. (condition “a”) Grubb's second generation catalyst, CHCl₃, 25° C. The coumarin moiety was incorporated into the monomer 3.3 because of its ability to cross-link. The material is known to undergo a [2+2] cyclization of the double bond on the ester functionalized 6-membered ring when exposed to light with wavelengths greater than 300 nm. The coumarin moiety is known to have a λₘₐₓ absorption at 320 nm. As the material photo-cross-links, the level of unsaturation

D=[(A₀−Aₜ)/A₀]×100% 3.1

decreases resulting in a decrease in the absorption at 320 nm. Due to this, the peak at 320 nm can be monitored to determine the degree of cross-linking following equation 3.1, where D is the degree of cross-linking, A₀ is the absorbance at 320 nm before irradiation, and Aₜ is the absorbance at 320 nm after irradiation. The triblock polymers 3.8a and 3.8b were dissolved in CH₂Cl₂ and irradiated with 365 nm light to induce cross-linking until increased exposure did not result in additional decrease in absorption at 320 nm. Using equation 3.1 the degree of cross-linking was determined to be 64.8% for polymer 3.8a and 51.8% for 3.8b, to form the cross-linked materials 3.9a and 3.9b respectively.

FIG. 12A is a schematic showing the crosslinking of triblock copolymers 3.8. FIG. 12B is a plot showing UV-Vis spectra of 3.8b in CH₂Cl₂ against irradiation time t with a 365 nm UV lamp. Initial testing focused on the extraction efficiencies for a liquid-liquid extraction. This was accomplished by mixing a solution of 10⁻⁴ M Th⁴⁺ in 1 M HNO₃ with equal volumes of an immiscible organic solution of polymer. Once bound to the polymer, the metal nitrates are pulled into the organic phase. The solubility of the homopolymer 2.9c in n-dodecane was investigated due to its use in the TRUEX process. It was determined that the polymer was not sufficiently soluble in n-dodecane and ultimately dichloromethane was chosen as the organic media for the extractions. The extraction of thorium(IV) was performed with varying concentrations of extracting material, 0.05 M-0.001 M. The results of these tests are summarized in the table below. At CMPO:Th⁴⁺ ratios of 10:1 all three polymers, 2.9c, 3.7a and 3.7b extract over 90% of the present thorium(IV). Table of extraction efficiencies for selected materials in liquid-liquid extractions.

| [CMPO] | 2.9c | 3.7a | 3.7b |
|---|---|---|---|
| 0.05 | 99.8 ± 0.2 | 99.93 ± 0.03 | 99.97 ± 0.03 |
| 0.01 | 99.947 ± 0.005 | 99.96 ± 0.01 | 98.3 ± 0.5 |
| 0.005 | 99.95 ± 0.01 | 99.962 ± 0.002 | 97 ± 3 |
| 0.001 | 93 ± 8 | 99 ± 1 | 99.2 ± 0.4 |

Percent of Th⁴⁺ extracted from 1M HNO₃ solutions by ligands. Aqueous phase: 10⁻⁴ M Th(NO₃)₄.H₂O, Organic phase: extracting materials in CH₂Cl₂.

Solid-liquid extractions were performed to decrease the volume of organic waste and to eliminate a volatile/flammable component in the extractions. The results are summarized in Table 3.2. The molarities given represent the moles of CMPO per the volume of the aqueous layer. To ensure that complexation was due to the presence of the CMPO moieties and not due to functional groups present in the other blocks, extraction tests were performed with homopolymers 3.5c and 3.6. It was found that homopolymers 3.5c and 3.6 at a concentration of 0.0029 g polymer per 6 mL of 10⁻⁴ M Th⁴⁺ in 1 M HNO₃ that less than 1% of the present thorium(IV) was extracted. Table of extraction efficiencies for selected materials in solid-liquid extractions.

| C_{CMPO} | 2.9c | 3.7a | 3.7b | 3.9a | 3.9b |
|---|---|---|---|---|---|
| 0.01 | 99.80 ± 0.04 | 99.86 ± 0.04 | 86 ± 3 | 93 ± 2 | 95 ± 1 |
| 0.005 | 99.2 ± 0.6 | 99.7 ± 0.2 | 88 ± 5 | 74 ± 4 | 89.7 ± 0.8 |
| 0.001 | 67 ± 7 | 99 ± 1 | 70 ± 3 | 7.7 ± 0.4 | 19 ± 6 |

Percent of Th⁴⁺ extracted from 1M HNO₃ solutions by ligands. Aqueous phase: 10⁻⁴ M Th(NO₃)₄H₂O.

Beginning with the homopolymer, 2.9c, in a thorium(IV) only extraction, it was seen that at 100:1 (CMPO:Th⁴⁺) and at 50:1 (CMPO:Th⁴⁺) over 90% of the thorium(IV) was uptaken from the aqueous layer into the solid polymer. In contrast to what was observed in the liquid-liquid extractions where the extraction value remains high at 10:1 (CMPO:Th⁴⁺), this value decreases to only 67% for the solid-liquid extraction. Similar results were observed for diblock copolymer 3.7b. In both the liquid-liquid and solid-liquid extractions, 3.7b uptakes over 86% of the thorium(IV) at 100:1 and 50:1 (CMPO:Th⁴⁺). At 10:1 (CMPO:Th⁴⁺) the extraction of thorium(IV) remains high (>99%) for the liquid-liquid extraction, but the amount of thorium(IV) extracted declines to 68% for the solid-liquid extraction. Diblock copolymer 3.7a unlike 3.7b uptakes over 98% of the thorium(IV) present in all three tested ratios. Our theory was that the presence of the long glycol chains would be beneficial in encouraging the interaction of the polymer with the aqueous media, increasing the contact of the CMPO units with the metal ions. It is possible that this is occurring and is causing the increase in performance seen by the diblock copolymer 3.7a, which has half the number of repeat units of the glycol chains as it does the number of repeat units of CMPO. 3.7b might also be experiencing a strong interaction with the aqueous media, but not incurring the same extraction values due to the fact that the larger ratio of glycol chains are blocking access to the CMPO units. To hinder the ability of the glycol units to encapsulate the CMPO moieties triblock copolymers incorporating a cross-linkable pendant group were synthesized. To mimic the two triblock polymers, these polymers also contain the CMPO and glycol chains in ratios of 2:1 and 2:4. The cross-linking groups were incorporated for both materials in a ratio of 2:1 with the CMPO units. These materials were also tested for their ability to extract thorium(IV) from an aqueous acidic medium into a solid polymer. The incorporation of the cross-linking groups negatively affected the extraction ability of the materials. While the two triblock terpolymers extract over 74% of the thorium(IV) for 100:1 and 50:1 (CMPO:Th), the performance at 10:1 (CMPO:Th) is quiet low, only 4% and 8% of the thorium(IV) was uptaken by the polymers 3.9a and 3.9b respectively. What is interesting is when we compare the performance of the two triblock terpolymers to that of the two diblock copolymers. In the case of the diblock copolymers more glycol chains hindered the performance of the material. When comparing 3.9a to 3.9b, it was seen that the material with more glycol chains, 3.9b, outperformed the material with fewer glycol chains, 3.9a. This evidence may support the theory that the cross-linked material does not allow the glycol chains to encapsulate the CMPO units, and thus more glycol chain units have the effect of only increasing the interactions with the aqueous media. Table of extraction efficiencies for selected materials in solid-liquid extractions at varying acid concentrations.

| | 1M | 4M |
|---|---|---|
| 2.9c | 99.2 ± 0.6 | 95.4 ± 0.9 |
| 3.7a | 99.6 ± 0.2 | 96.1 ± 0.2 |
| 3.7b | 87 ± 5 | 92 ± 2 |
| 3.9a | 74 ± 4 | 87 ± 4 |
| 3.9b | 89.7 ± 0.8 | 88.97 0.09 |

Percent of Th⁴⁺ extracted from 1 M and 4 M HNO₃ solutions by ligands, C_{CMPO}=5×10⁻³ M. Aqueous phase: 10⁻⁴ M Th(NO₃)₄.H₂O. The extraction abilities of the materials were also tested in 4 M nitric acid. It was observed that for all five polymers the amount of thorium(IV) extracted does not change significantly (<4%) between 1 M HNO₃ and 4 M HNO₃, except for polymer 3.9a, which actually extracts more thorium(IV) at the higher acid concentration.

Percent of Th⁴⁺ extracted from 1 M HNO₃ solutions by ligands, C_{L}=5×10⁻³M. Aqueous phase: 10⁻⁴ M Th(NO₃)₄H₂O. The timescale on which extractions occur was investigated using homopolymer 2.9c. The extraction of thorium(IV) was performed with contact times of 1 minute, 30 minutes, 1 hour, and 20 hours, see Table 3.4. After only 1 minute over 50% (i.e., 60%) of the thorium(IV) was extracted, 30 minutes over 80% (i.e., 81%) of the thorium(IV), 1 hour over 90% (i.e., 93%) of the thorium(IV) to be extracted and 1 hour 20 minute for over 99% (i.e., 99%) of the thorium(IV) to be extracted.

The selectivity for thorium(IV) over the lanthanides europium(III), lanthanum(III) and cerium(III) was investigated see Table 3.5. It was found that the homopolymer 2.9c, the diblock copolymer 3.7b, and the triblock copolymers 3.9a and 3.9b were selective for thorium(IV). The diblock copolymer 3.7a was found to be indiscriminate for thorium(IV) over the lanthanides(III). The two diblocks were the lowest performing materials from the set and did not outperform the homopolymer. The triblock copolymers 3.9a and 3.9b were over 2 times more selective than the homopolymer 2.9c, with 3.9a being more selective than 3.9b. Table of extraction and separation efficiencies for selected materials in solid-liquid extractions.

| | 2.9c | 3.7a | 3.7b | 3.8a | 3.8b |
|---|---|---|---|---|---|
| % Th | 97.8 ± 0.5 | 64 ± 8 | 89 ± 5 | 81 ± 6 | 96.2 ± 0.7 |
| % Eu | 49 ± 3 | 80 ± 3 | 80 ± 4 | 9 ± 3 | 21 ± 3 |
| X_{Th/Eu} | 2.0 | 0.8 | 1.1 | 8.9 | 4.6 |
| % La | 65 ± 4 | 90 ± 1 | 77 ± 2 | 12 ± 4 | 20 ± 4 |
| X_{Th/La} | 1.5 | 0.7 | 1.2 | 6.9 | 4.9 |
| % Ce | 67 ± 4 | 87 ± 5 | 84 ± 4 | 13 ± 4 | 14 ± 4 |
| X_{Th/Ce} | 1.5 | 0.7 | 1.1 | 6.3 | 6.7 |

Percentage of Th⁴⁺, Eu³⁺, La³⁺, and Ce³⁺ (C_{M}=2.5×10⁻⁴M) extracted by polymeric materials (C_{CMPO}=5×10⁻³ M) and separation ratios X_{Th/M}.

A series of block polymers containing CMPO pendent groups have been synthesized, characterized and the ability of the materials to efficiently and selectively extract thorium(IV) has been evaluated. Liquid-liquid extractions revealed that polymers 2.9c, 3.7a, and 3.7b have high affinities (>99%) for Th⁴⁺ even at low concentrations of ligand (ligand:Th⁴⁺ 10:1). Solid-liquid extractions revealed that all of the materials had high affinities (>85%) at sufficiently high ligand concentrations (CMPO:Th⁴⁺ 100:1). The incorporation of blocks of long glycol chains has caused improvements in extraction of thorium(IV) as compared to the homopolymer. At lower ligand concentrations, only diblock copolymer 3.7a had high affinities. At 4 M HNO₃ each material extracted comparable amounts of thorium(IV) as compared to extractions with 1 M HNO₃. A time dependence study revealed that within 30 min, over of 80% of the thorium(IV) is removed. The selectivity for thorium(IV) over lanthanum(III), europium(III), and cerium(III) was also tested. The triblock copolymers had the highest selectivies, followed by the homopolymers, then the diblock copolymers. The incorporation of both long glycol chains and cross-linking groups has caused improvements in the selectivity of the materials as compared to the homopolymer. Examples of multi-block polymers include Diblock Copolymer 3.7a; Diblock Copolymer 3.7b; Triblock terpolymer 3.9a; Triblock terpolymer 3.9b and homopolymer includes HomoPolmyer 2.9c.

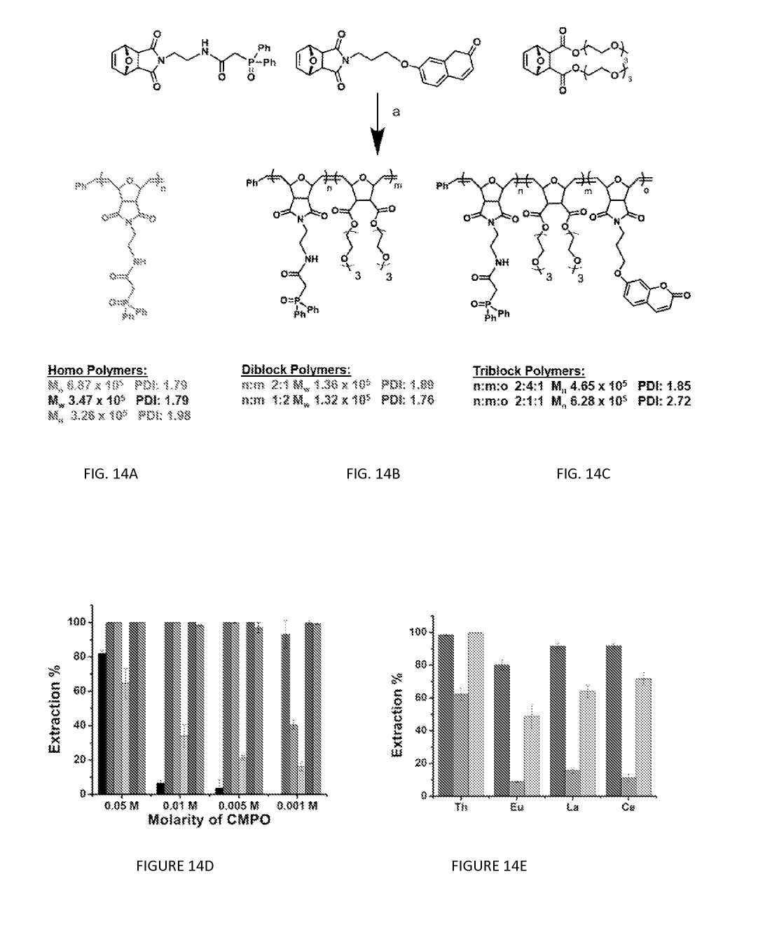

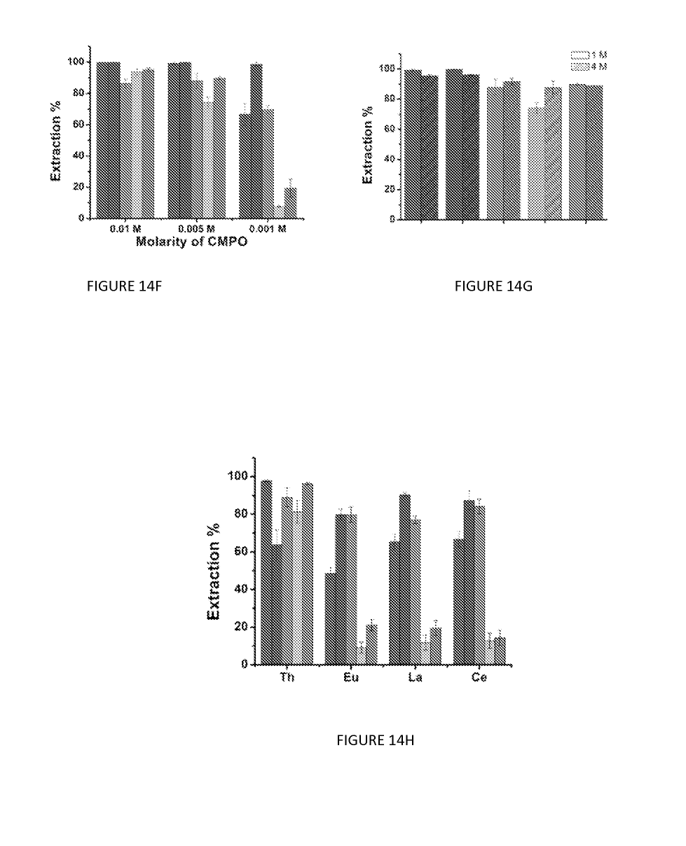

FIGS. 14A-14C are schematics of three embodiments of variations of polymers of the present invention which include homopolymers (FIG. 14A), diblock copolymers (FIG. 14B) and triblock terpolymers (FIG. 14C) of different molecular weights.

FIG. 14A shows homopolymers of different molecular weights, e.g., 6.87×10⁵, 3.84×10⁵, 3.47×10⁵, 3.26×10⁵, 1.94×10⁵, and 1.64×10⁵, wherein the smallest polymer extracted the highest percentage of thorium and outperformed the monomer. FIG. 14B shows diblock copolymers having different ratios, e.g., n:m 2:1 with a Mw 1.36×10⁵ and n:m 2:4 Mw 1.32×10⁵. FIG. 14C shows triblock terpolymers having different ratios, e.g., n:m:o 2:1:1 Mw 6.28×10⁵ and n:m:o 2:4:1 Mw 4.65×10⁵.

For the liquid-liquid extractions 0.6 mL of aqueous and organic phases (polymers dissolved in CH₂Cl₂) were mixed in a 1 dram glass vial equipped with a polyethylene cap and PTFE coated stir bars. The vials were stirred at 1200 rpm for 20 hrs. The solutions were then centrifuged and the aqueous layer pipetted off the top and transferred to a 1 mL centrifuge tube. The solution was centrifuged again and the top layer was diluted to 15-30 ppb.

FIG. 14D is a plot of the percent extraction of Th⁴⁺ in a liquid-liquid extraction as a function of molarity of CMPO (from left to right) the first bar is the monomer; a homopolymer with M_{W} 3.26×10⁵; a homopolymer with M_{W} 3.47×10⁵; a homopolymer with M_{W} 6.87×10⁵; a diblock polymer with a n:m ratio of 2:1 and a Mw 1.36×10⁵ and a diblock polymer with a n:m ratio of 2:4 and a Mw 1.32×10⁵. The extraction efficiencies of the CMPO monomer, and homopolymers were examined and the efficiencies were tested by performing a liquid-liquid extraction with metal nitrates in aqueous acidic media, which were extracted into organic media by ligands in the organic phase. The extraction of thorium was performed with varying concentrations of extracting material, 0.05M-0.001M. The concentration of the polymeric materials was determined by using by using the same gram quantity as the monomer at each concentration, giving one mole of repeat unit per liter. For the CMPO monomer, high extraction values could be obtained with 1000 times greater ligand to metal concentration, but sharply declined to 7% at 100 times greater concentration. All the polymeric materials outperformed the monomer. The homopolymers with a m.w. of 1.94×10⁵ and 1.64×10⁵ were able to achieve quantitative extractions at only 50 times greater ligand to metal concentration. Though the performance of the homopolymer with a m.w. of 1.94×10⁵ sharply declines at 10 times ligand to metal concentration, the homopolymer with a m.w. of 1.64×10⁵ still extracts over 90% of the metal ions. Quantitative extraction was not achieved with the homopolymer with a m.w. of 3.84×10⁵ and at very high ligand concentrations the monomer does outperform the homopolymer with a m.w. of 3.84×10⁵, but as the concentration of the materials is decreased the polymer significantly outperforms the monomer. At 0.01M, for example, the polymer binds to 5 times more Th⁴⁺ than the monomer. It is believed that as the concentration of monomer is decreased it becomes more and more difficult for three CMPO ligands to find a metal ion and complete extraction. As the concentration of the polymer is decreased the “localized concentration” remains the same; that is many CMPO ligands are grouped together despite the solution being somewhat dilute. Because of this the CMPO ligands can take place in cooperative binding in the case of the polymers, but not in the case of the monomers.

FIG. 14E is a plot of the percent extraction of Th⁴⁺, La³⁺, Eu³⁺, and Ce³⁺ in a liquid-liquid extraction with 0.01 M CMPO homopolymers, (from left to right for each element) a homopolymer with M_{W} 3.26×10⁵; a homopolymer with M_{W} 3.47×10⁵; and a homopolymer with M_{W} 6.87×10⁵. To determine the separation efficiency of the materials, lanthanides were added to the extractions. Three lanthanides were chosen: lanthanum, europium, and cerium. The lanthanide and actinide salts, Th(NO₃)₄.H₂O (Strem), Ce(NO₃)₃.6H₂O (Alfa Aesar), Eu(NO₃)₃.5H₂O (Strem), and La(NO₃)₃.6H₂O (Fisher), were used as received. Solutions were prepared using trace metal grade deionized water, trace metal grade HNO₃ (BDH), and twice distilled CH₂Cl₂. Three aqueous solutions were prepared: a solution of 10⁻⁴ M Th⁴⁺ in 1 M HNO₃, a solution of 10⁻⁴ M Th⁴⁺ in 4 M HNO₃, and a solution of 2.5×10⁻⁵M Th⁴⁺, 2.5×10⁻⁵M Eu³⁺, 2.5×10⁻⁵M Ce³⁺ and 2.5×10⁻⁵M La³⁺ in 1 M HNO₃. To keep the same overall metal concentration of 10⁻⁴ M, the concentration of each individual metal was set at 2.5×10⁻⁵ M, so the final solution contained 2.5×10⁻⁵ M Th⁴⁺, La³⁺, Eu³⁺, and Ce³⁺ The percentage of each individual metal extracted was converted to a distribution of ions in each phase using an equation given in the supporting information. The separation values were determined by dividing the distribution of thorium by the distribution of a given ion. A larger value indicates a higher preference to extract thorium over a given ion. Table of the separation efficiencies for polymeric materials:

| | 3.84 × 10⁵ | 1.94 × 10⁵ | 1.64 × 10⁵ |
|---|---|---|---|
| S_{Th/Eu} | 327.7 | 16.7 | 15.6 |
| S_{Th/La} | 175.6 | 18.7 | 5.7 |
| S_{Th/Ce} | 123.8 | 13.0 | 5.7 |

S_{Th/m} values for extraction of Th⁴⁺, Ce³⁺, La³⁺, and Eu³⁺ (2.5×10⁻⁵ M) from an aqueous solution of 1M HNO₃ into a DCM solution of polymers (0.01 M) at 25° C. It is clear that all the materials have a preference for thorium over the lanthanides. The highest molecular weight polymer, homopolymer with a m.w. of 3.84×10⁵, is the most discriminate towards thorium, with a much higher separation values than the other materials. The smallest molecular weight polymer has the lowest separation values for all of the ions tested, revealing a trend of better separations with higher molecular weight materials. The trend of increasing separation efficiency with increasing size has also been shown between single CMPO systems and platform CMPO systems, where multiple CMPO containing systems have shown a higher preference for actinides than homologous single CMPO containing systems. The high extraction efficiencies with the smaller polymer and the high separation efficiencies with the higher molecular weight polymer shows there is a so called “sweet-spot” for idealized molecular weight, where both extraction and separation efficiencies can be maximized.

Solid-liquid extractions provide decreasing the volume of organic waste and eliminating a volatile/flammable component in the extractions. The molarities given represent the moles of CMPO per the volume of the aqueous layer. To ensure that complexation was due to the presence of the CMPO moieties and not due to functional groups present in the other blocks, extraction tests were performed with homopolymers 3.5 and 3.6. It was found that homopolymers 3.5 and 3.6 at a concentration of 0.0029 g polymer per 6 mL of 10⁻⁴ M Th⁴⁺ in 1 M HNO₃ extracted less than 1% of the thorium(IV) that was present. The solid-liquid extractions were performed by weighing solid polymers into 1 dram glass vials and adding 0.6 mL of a metal nitrates in nitric acid. The molarities reported represent the moles of each CMPO repeat unit per 0.6 mL. Due to the varying ratio of blocks in each polymer, different masses of each polymer were required to reach the same concentration of CMPO in solution. The solution was mixed for 20 hrs., unless otherwise noted, at 1200 rpm. The solution was centrifuged and the aqueous layer decanted off the solid material and transferred to a 1 mL centrifuge tube. The solution was centrifuged again to remove any remaining solid materials and the top later was diluted to 15-30 ppb with 2% HNO₃. For both the liquid-liquid and solid-liquid extractions the diluted solutions were counted in triplicate using a GBC Optimass 8000 ICP-time-of-flight (TOF)-MS (GBC Scientific Equipment, Hampshire, Ill.) or a PerkinElmer NexION 300D ICP-MS.

FIG. 14F is a plot of the percent extraction of Th⁴⁺ in a solid-liquid extraction as a function of molarity of CMPO with (from left to right) the first bar is a monomer; a homopolymer with M_{W} 3.26×10⁵; a diblock polymer with a n:m ratio of 2:1 and a Mw 1.36×10⁵; a diblock polymer with a n:m ratio of 2:4 and a Mw 1.32×10⁵; a triblock polymer with a n:m:o ratio of 2:1:1 and a Mw 6.28×10⁵ and a triblock polymer with a n:m:o ratio of 2:4:1 and a Mw 4.65×10⁵.

Beginning with the homopolymer, in a thorium(IV) only extraction it was determined that at 100:1 (CMPO:Th⁴⁺) and at 50:1 (CMPO:Th⁴⁺) over 90% of the thorium(IV) was uptaken from the aqueous layer into the solid polymer. In contrast to what was observed in the liquid-liquid extractions where the extraction value remains high at 10:1 (CMPO:Th⁴⁺), this value decreases to only 67% for the solid-liquid extraction. Similar results were observed for diblock copolymer with a n:m ratio of 2:4 and a Mw 1.32×10⁵. In both the liquid-liquid and solid-liquid extractions, diblock polymer with a n:m ratio of 2:4 and a Mw 1.32×10⁵ uptakes over 86%. Diblock copolymer diblock polymer with a n:m ratio of 2:1 and a Mw 1.36×10⁵ unlike diblock polymer with a n:m ratio of 2:4 and a Mw 1.32×10⁵ uptakes over 98% of the thorium(IV) present in all three of the concentrations tested. We speculate that the presence of the long glycol chains would be beneficial in encouraging the interaction of the polymer with the aqueous media, increasing the contact of the CMPO units with the metal ions. It is possible that this is occurring and is causing the increase in performance seen by the diblock copolymer with a n:m ratio of 2:1 and a Mw 1.36×10⁵, which has half the number of repeat units.

While the two triblock terpolymers extract over 74% of the thorium(IV) for 100:1 and 50:1 (CMPO:Th), the performance at 10:1 (CMPO:Th) is quiet low, only 4% and 8% of the thorium(IV) was uptaken by the triblock terpolymer with a n:m:o ratio of 2:1:1 and a Mw 6.28×10⁵ and triblock terpolymer with a n:m:o ratio of 2:4:1 and a Mw 4.65×10⁵ respectively. It is interesting to compare the performance of the two triblock terpolymers to that of the two diblock copolymers. In the case of the diblock copolymers more glycol chains hindered the performance of the material. When comparing triblock terpolymer with a n:m:o ratio of 2:1:1 and a Mw 6.28×10⁵ to triblock terpolymer with a n:m:o ratio of 2:4:1 and a Mw 4.65×10⁵, it was seen that the material with more glycol chains, triblock terpolymer with a n:m:o ratio of 2:4:1 and a Mw 4.65×10⁵, outperformed the material with fewer glycol chains, triblock terpolymer with a n:m:o ratio of 2:1:1 and a Mw 6.28×10⁵. This evidence may support the theory that the cross-linked material does not allow the glycol chains to encapsulate the CMPO units, and thus more glycol chains have the effect of only increasing the interactions with the aqueous media.

The extraction abilities of the materials were also tested in 4 M nitric acid, see FIG. 6. It was observed that for all five polymers the amount of thorium(IV) extracted does not change significantly (<4%) between 1 M HNO₃ and 4 M HNO₃, except for polymer triblock terpolymer with a n:m:o ratio of 2:1:1 and a Mw 6.28×10⁵, which actually extracts more thorium(IV) at the higher acid concentration. This demonstrates a promising, and perhaps surprising, stability of these polymer materials to high acid concentrations.

FIG. 14G is a plot of the percent extraction of Th⁴⁺ in a solid-liquid extraction for 0.005M CMPO as a function of molarity of acid with (from left to right) the first pair of bars are the monomer; the next pair of bars are the diblock copolymer with a n:mratio of 2:1 and a Mw 1.36×10⁵; the next pair of bars are the diblock copolymer with a n:m ratio of 2:4 and a Mw 1.32×10⁵; the next pair of bars are the triblock terpolymer having a n:m:o ratio of 2:1:1 and a Mw 6.28×10⁵ and the next pair of bars are the triblock terpolymer having a n:m:o ratio of 2:4:1 and a Mw 4.65×10⁵.

FIG. 14H is a plot of the percent extraction of Th, Eu, La, and Ce in a solid-liquid extraction with 0.005 M CMPO polymers, (from left to right for each element) a homopolymer with M_{W} 3.26×10⁵; a diblock copolymer with a n:m ratio of 2:1 and a Mw 1.36×10⁵; the next pair of bars are the diblock copolymer with a n:m ratio of 2:4 and a Mw 1.32×10⁵; the next pair of bars are the triblock terpolymer having a n:m:o ratio of 2:1:1 and a Mw 6.28×10⁵ and the next pair of bars are the triblock terpolymer having a n:m:o ratio of 2:4:1 and a Mw 4.65×10⁵.

In a liquid-liquid extraction system the most Th⁴⁺ was extracted by the homopolymer with M_{W} 3.26×10⁵ followed by the homopolymer with M_{W} 3.47×10⁵ followed by the homopolymer with M_{W} 6.87×10⁵. The most selective homopolymer was the homopolymer with M_{W} 3.47×10⁵ followed by the homopolymer with M_{W} 6.87×10⁵ followed by the homopolymer with M_{W} 3.26×10⁵.

In a solid-liquid extraction system the most Th⁴⁺ was extracted by the diblock copolymers with n:m 2:1 with a Mw 1.36×10⁵ followed by the diblock copolymers with a n:m 2:4 Mw 1.32×10⁵ followed by the homopolymer with M_{W} 3.26×10⁵ followed by the triblock terpolymers having n:m:o 2:4:1 Mw 4.65×10⁵ followed by the triblock terpolymers having n:m:o 2:1:1 Mw 6.28×10⁵. The most selective in a solid-liquid extraction system the triblock terpolymers having n:m:o 2:1:1 Mw 6.28×10⁵ followed by the triblock terpolymers having n:m:o 2:4:1 Mw 4.65×10⁵ followed by the homopolymer with M_{W} 3.26×10⁵ followed by the diblock copolymers with a n:m 2:4 Mw 1.32×10⁵ followed by the diblock copolymers with n:m 2:1 with a Mw 1.36×10⁵.

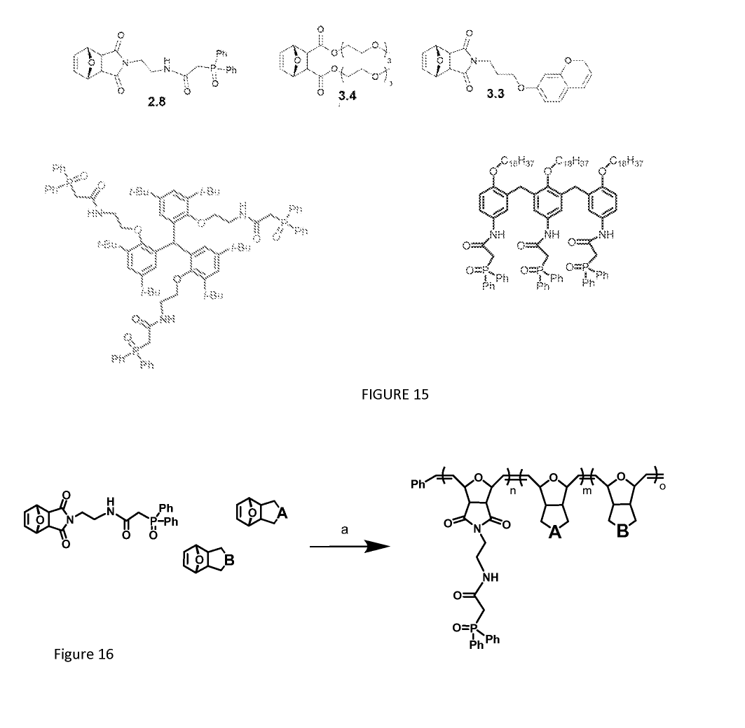

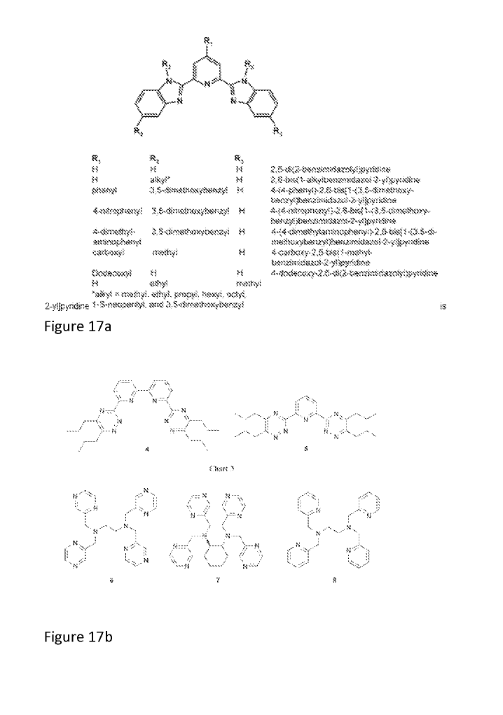

The present invention provides numerous combinations of monomers that may be combined to form a polymer. FIG. 15 is an image of some of the monomers of the present invention. FIG. 16 is an image of some of the monomers polymerized into multi-block polymers having different pendent groups A and B that may be changed depending on the specific purpose. FIGS. 17a and 17b are images of some of the ligands of the present invention.

The present invention provides numerous combinations of monomers that may be combined to form a polymer. The polymer backbone may be random alternating copolymers in addition to block copolymers. The polymer backbone may be made by anionic vinyl polymerization, carbocationic polymerization, radical polymerization, living transition metal-catalyzed alkene polymerization, ring-opening polymerization of hetrerocyclic monomers or ring-opening metathesis polymerization.

The present invention provides ring-opening metathesis polymerization backbones made from norbornene, oxanorbornene, 1-methyl-1,5-cyclooctadiene, or 3a,4,7,7a-tetrahydro-1H-4,7-methanoindene. The linker between the polymer backbone and the ligands may be alkyl linkers of different lengths (e.g., 2, 3, 4, 5, 6, 7, 8, 9, 10 or more) or polyethylene glycol linkers of different lengths.

The solubilizing groups on the second monomer include single and multiple solubilizing chains, polyethylene glycol chains of different lengths, alkyl chains of various lengths, and perfluoro alkyl chains of various lengths. The crosslinking groups on the third monomer include groups used for crosslinking chemistry such as vinyl groups. Examples of ligands that may be attached to the polymer backbone include: 2,4,6-tri(2-pyridyl)-1,3,5-triazine (TPTZ); bis-(2-pyridylmethyl)amine; tris(2-pyridylmethyl)amine; tris(6-methylpyrid-2-yl)amine; 2,2′-Bipyridine; 4′-methylterpyridine; 4′-octylterpyridine; 4′-phosphonatoterpy; 2,2′: 6′,2″: 6″,2′″-quaterpyridyl; 2,6-di(2-benzimidazolyl)pyridine; 2,6-bis(1,2,4-triazin-3-yl)pyridine; Dimethylthiophosphate (DMTP); 2,6-di(2-pyridyl)pyrimidine; 2-amino-4,6-di(2-pyridyl)-1,3,5-triazine; tris[(6-methyl-2-pyridyl)methyl]amine; tris(2-pyrazylmethyl)amine; N,N′-bis(2-pyridylmethyl)-1,2-ethanediamine; N,N′-bis(2-pyridylmethyl)-1,3-propanediamine; N,N′-bis(2-pyridylmethyl)-1,4-butanediamine; N,N,N′,N′-tetrakis(2-pyridylmethyl)-1,2-ethanediamine; 2,6-di(1,2,4-triazin-3-yl)pyridine; 2,6-bis(5,5,8,8-tetramethyl-5,6,7,8-tetrahydrobenzo-1,2,4-triazin-3-yl)pyridine; 2,6-bis(9,9,10,10-tetramethyl-9,10-dihydrobenzo-1,2,4-triazaanthrane-3-yl)pyridine; 6,6′-bis(1,2,4-triazin-3-yl)-2,2′-bipyridyl; N,N′-dimethyl-N,N′-dioctyl-2-(2-hexoxyethyl)malonamide; 2,6-bis[1-(1-S-neopentyl)benzimidazol-2-yl]pyridine; 4-carboxy-2,6-bis (1-methylbenzimidazol-2-yl)pyridine neopentyl ester; 6,6′-bis(5,6-dialkyl-1,2,4-triazin-3-yl)-2,2′-bipyridines; 6,6′-bis(5,5,8,8-tetramethyl-5,6,7,8-tetrahydrobenzo-1,2,4-triazin-3-yl)-2,2′-bipyridine; ethylenediaminetetraacetic acid (EDTA); diethylenetriaminepentaacetic acid (DTPA); citrate; humic acid; fulvic acid; nitrilotriacetic acid (NTA); Maltol; Catechol; Hydroxamic acid; 2-Hydroxypyridine-N-oxide (HOPO) and it's derivatives; 2,3-dihydroxyterephthalamide and it's derivatives; sulfonamide catecholates (or SFAM ligands); octyl-(phenyl)-N,N-diisobutyl carbamoyl methyl phosphine oxide (CMPO) (and derivatives); N,N′-dimethyl-N,N′-dibutyl tetradecyl malonamide (DMDBTDMA); N,N′-dimethyl-N,N′-dioctyl-2-(2-hexyloxyethyl)malonamide (DMDOHEMA); diglycolamide and its derivatives; bis(2-ethylhexyl) butyramide; 2,9-bis(1,2,4-triazin-3-yl)-1,10-phenanthroline; dithiophosphinic acid derivatives; cobalt bis(dicarbollide) derivatives; picolineamid derivatives; N,N,N′,N′-Tetraoctyl-3,6-dioxaoctanediamide; N,N-dialkyldiglycolamicacids; 6,6′-bis(aryl)-5,5′-bi-1,2,4-trazines; Cyanex 301; Cyanex 302; Cyanex 272; 2-(Diphenyl-N,N-diethylcarbamoylmethylphosphine oxide)pyridine and its N-oxide; 2-[(Diphenyl-N,N-diethylcarbamoylmethylphosphine oxide)methyl]pyridine and its N-oxide; 2,6-Bis(diphenyl-N,N-diethylcarbamoylmethylphosphine oxide)pyridine and its N-oxide; 2,6-Bis[(diphenyl-N,N-diethylcarbamoylmethylphosphine oxide)methyl]pyridine and its N-oxide; 4-hydroxy-N′N-dialkylbutanamide and its derivatives; 1,2,4-triazine-picolinamide; Picolinamides; 4-amino-2,6-di-2-pyridyl-1,3,5-triazine; or 2,6-bis(benzoxazol-2-yl)-4-dodecyloxypyridine.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claims is:

1. A multi-block polymer composition for selective sequestration and separation of actinides and/or lanthanides comprising:
a first block polymer comprising one or more CMPO monomers each having a first backbone bound to a pendant carbomylmethylphosphine oxide group; and
a second block polymer comprising one or more second monomers each having a second backbone bound to a second pendant group, wherein the first backbone is polymerized to the second backbone to form a polymer backbone with pendent blocks of the second pendant group and pendent blocks of pendent carbomylmethylphosphine oxide group that sequester the multivalent ions.

2. The composition of claim 1, wherein the actinides and/or lanthanides are selected from Th⁴⁺, La³⁺, Eu³⁺, and Ce³⁺.

3. The composition of claim 1, wherein the actinides and/or lanthanides are Th⁴⁺.

4. The composition of claim 1, wherein the multi-block polymer composition is in solution, in suspention or disposed on a porous inert resin or silica support.

5. The composition of claim 1, wherein the ratio of one or more CMPO monomers to one or more second monomers is 2:1 or 1:2.

6. The composition of claim 1, wherein the ratio of one or more CMPO monomers to one or more second monomers is 2:1 with a Mw of about 1.36×10⁵ or 1:2 with a Mw of about 1.32×10⁵.

7. The composition of claim 1, wherein the second pendant group comprises one or more long glycol chains and preferably comprises 2 polyethylene glycol groups

8. The composition of claim 1, wherein the first block polymer and the second block polymer are the same to form a homopolymer.

9. The composition of claim 1, further comprising a third block polymer comprising one or more third monomers each having a third backbone bound to a third pendant group, wherein the one or more third monomers is polymerized to the first backbone and the second backbone.

10. The composition of claim 1, wherein the ratio of one or more CMPO monomers to one or more second monomers to one or more third monomers is 2:1:1 a Mw of about 6.28×10⁵ or 2:4:1 a Mw of about 6.28×10⁵.

11. The composition of claim 10, wherein the second pendant group is 2 polyethylene glycol groups and the third pendant group comprises a hydroxcoumarian group.

12. The composition of claim 11, wherein the hydroxcoumarian group is at least partially crosslinked.

13. A process for separating actinides and/or lanthanides in the processing of a nuclear fuel comprising the steps of:
providing a fluid mixture comprising fission products, lanthanides, actinides, nitric acid and water;
providing a multi-block extractant polymer for selective sequestration and separation of separating actinides and/or lanthanides comprising a first block polymer comprising one or more CMPO monomers each having a first backbone bound to a pendant carbomylmethylphosphine oxide group; a second block polymer comprising one or more second monomers each having a second backbone bound to a second pendant group, wherein the first backbone is polymerized to the second backbone to form a polymer backbone with pendent blocks of the second pendant group and pendent blocks of pendent carbomylmethylphosphine oxide group that sequester the actinides and/or lanthanides; and optionally a third block polymer comprising one or more third monomers each having a third backbone bound to a third pendant group, wherein the one or more third monomers is polymerized to the first backbone and the second backbone;
contacting the multi-block extractant polymer with the fluid mixture for the sequestration of the actinides and/or lanthanides by the pendant carbomylmethylphosphine oxide groups; and
separating the multi-block extractant polymer from the fluid mixture to separate the actinides and/or lanthanides from the fluid mixture.

14. The process of claim 13, further comprising the step of disassociating the pendant carbomylmethylphosphine oxide group from the actinides and/or lanthanides and collecting the actinides and/or lanthanides.

15. The process of claim 13, wherein the multi-block polymer composition is in solution, in suspention or disposed on a porous inert resin or silica support for solid-liquid extractions.

16. The process of claim 13, wherein the ratio of one or more CMPO monomers to one or more second monomers to one or more third monomers is 2:1:0 with a Mw of about 1.36×10⁵; 1:2:0 with a Mw of about 1.32×10⁵; 2:1:1 with a Mw of about 6.28×10⁵; or 2:4:1 a Mw of about 6.28×10⁵.

17. The process of claim 13, wherein the one or more second monomers each comprise 2 polyethylene glycol groups.

18. The process of claim 13, wherein the one or more second monomers each comprise one or more glycol chains and the one or more third monomers comprises a hydroxcoumarian group.

19. The process of claim 13, wherein the hydroxcoumarian groups are at least partially crosslinked.

20. The process of claim 13, wherein the actinides and/or lanthanides is Th⁴⁺.

21. A polymeric extractant with pendant chelator groups for selective sequestration of actinides and/or lanthanides comprising:
a first block polymer comprising one or more CMPO monomers each having a first backbone bound to a pendant carbomylmethylphosphine oxide group;
a second block polymer comprising one or more second monomers each having a second backbone bound to a second pendant group, wherein the first backbone is polymerized to the second backbone to form a polymer backbone with pendent blocks of the second pendant group and pendent blocks of pendent carbomylmethylphosphine oxide group that sequester the actinides and/or lanthanides; and
optionally a third block polymer comprising one or more third monomers each having a third backbone bound to a third pendant group, wherein the one or more third monomers is polymerized to the first backbone and the second backbone.

22. The composition of claim 21, wherein the multi-block polymer composition is disposed on a porous inert resin or silica support for use in a solid liquid extraction process.

23. The composition of claim 21, wherein the ratio of one or more CMPO monomers to one or more second monomers to one or more third monomers is 2:1:0; 1:2:0; 2:1:1; or 2:4:1.

24. The composition of claim 21, wherein the ratio of one or more CMPO monomers to one or more second monomers to one or more third monomers is 2:1:0 with a Mw of about 1.36×10⁵; 1:2:0 with a Mw of about 1.32×10⁵; 2:1:1 with a Mw of about 6.28×10⁵; or 2:4:1 a Mw of about 6.28×10⁵.

25. The composition of claim 21, wherein the pendent blocks of pendent carbomylmethylphosphine oxide group sequester actinides.

26. The composition of claim 1, wherein the one or more second monomers each comprise one or more glycol chains and the one or more third monomers comprises a hydroxcoumarian group.

27. The composition of claim 18, wherein the hydroxcoumarian groups are at least partially crosslinked.

28. A multi-block polymer composition for selective sequestration of ions having the structure: 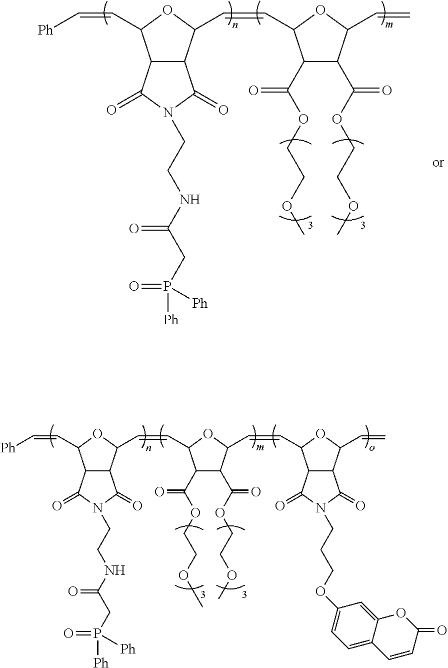
wherein the ratio of one or more CMPO monomers to one or more second monomers is 2:1 with a Mw of about 1.36×10⁵; the ratio of one or more CMPO monomers to one or more second monomers is 1:2 with a Mw of about 1.32×10⁵; the ratio of one or more CMPO monomers to one or more second monomers to one or more third monomers is 2:1:1 a Mw of about 6.28×10⁵; or the ratio of one or more CMPO monomers to one or more second monomers to one or more third monomers is 2:4:1 a Mw of about 6.28×10⁵.

29. The composition of claim 28, wherein the hydroxcoumarian groups are at least partially crosslinked.

30. A multi-block polymer composition for selective sequestration actinides and/or lanthanides comprising:
1 or more blocks of monomers polymerized to form a multiblock polymer, wherein the 2 or more blocks of monomers are selected from
one or more CMPO monomers having the structure 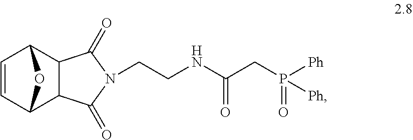 [SMILES: O=C(CP(=O)(c1ccccc1)c1ccccc1)NCCN1C(=O)C2C(C1=O)[C@H]1C=C[C@@H]2O1]
one or more second monomers having the structure, 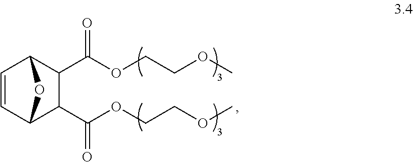
and
one or more third monomers having the structure 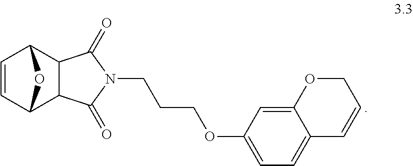 [SMILES: O=C1C2C(C(=O)N1CCCOc1ccc3c(c1)OCC=C3)[C@H]1C=C[C@@H]2O1]
